(19) United States
(12) Patent Application Publication
(10) Pub. No.: US 2018/0212235 A1
(43) Pub. Date: Jul. 26, 2018

(54) LITHIUM SECONDARY BATTERY AND METHOD FOR MANUFACTURING SAME

(71) Applicant: NEC Corporation, Tokyo (JP)

(72) Inventors: Tetsuya KAJITA, Tokyo (JP); Jiro IRIYAMA, Tokyo (JP); Shin SERIZAWA, Tokyo (JP)

(73) Assignee: NEC Corporation, Tokyo (JP)

(21) Appl. No.: 15/925,576

(22) Filed: Mar. 19, 2018

Related U.S. Application Data
(62) Division of application No. 14/389,011, filed on Sep. 29, 2014.

(30) Foreign Application Priority Data
Mar. 30, 2012 (JP) 2012-081118

(51) Int. Cl. H01M 4/36; H01M 4/38; H01M 2/02; H01M 4/04; H01M 4/131; H01M 4/134; H01M 10/0569; H01M 10/052; H01M 4/485; H01M 4/48; H01M 4/1395; H01M 4/1391; H01M 4/62; H01M 4/02

(52) U.S. Cl. CPC H01M 4/364; H01M 2300/0028; H01M 2/0237; H01M 2/0267; H01M 4/0404; H01M 4/131; H01M 4/134; H01M 10/0569; H01M 10/052; H01M 4/485; H01M 4/48; H01M 2/0202; H01M 4/1395; H01M 4/1391; H01M 4/366; H01M 4/625; H01M 2004/027; H01M 2220/20; H01M 2220/30; H01M 4/386

(57) ABSTRACT

Provided are a lithium secondary battery wherein gas generation associated with charging and discharging can be suppressed even in case where silicon and silicon oxide are contained as negative electrode active materials, and wherein deformation due to the gas generation can be suppressed even in case where a resin film is used as an outer package; and a method for manufacturing the lithium secondary battery. A lithium secondary battery comprises a negative electrode containing a negative electrode active material, a positive electrode containing a positive electrode active material, and an electrolytic solution used to immerse the negative electrode active material and the positive electrode active material, wherein the negative electrode active material contains silicon and silicon oxide that have been subjected to a reduction treatment.

### TECHNICAL FIELD

The present invention relates to a lithium secondary battery including a negative electrode comprising a negative electrode active material containing silicon and silicon oxide, and a method for manufacturing the same.

### BACKGROUND

Lithium secondary batteries which reversibly absorb and release lithium ions on positive and negative electrodes and allow repetitive charge/discharge because of using an organic solvent are widely used in portable electronic devices or personal computers, in particular, batteries for operating motors for hybrid electric vehicles and the like. While these lithium secondary batteries are required further miniaturization and weight lightening, increase in capacity of batteries due to increase in amount of lithium ions reversible absorption and release on positive and negative electrodes and reduction in cycle deterioration resulting from charge/discharge are required as important problems.

In lithium secondary batteries, silicon as a negative electrode active material has high capacity due to high amounts of lithium ions of absorption and release per unit volume, but fine powders are dropped off from negative electrode during the first charge/discharge due to large expansion and contraction of volume resulting from absorption and release of lithium ions and thereafter amounts of lithium ions of reversible absorption and release on positive and negative electrodes are prone to decrease upon following charge/discharge. To reduce an amount of irreversible capacity upon the first charge/discharge, silicon oxide is used in conjunction with silicon to suppress variation in volume of the negative electrode resulting from absorption and release of lithium ions. However, silicon oxide involves gas generation upon charge/discharge, in particular, in the case where an electrolytic solution contains ester carbonate, this tendency becomes greater. In recent years, batteries for vehicles or power storage devices which outer packages are made from aluminum foil laminated by resin are developed to expand thickness and weight reduction. When the batteries contain silicon oxide as the negative electrode, the battery using the aluminum laminated film for outer packages may be deformed due to gas generated upon charge/discharge.

Methods for suppressing gas generation in batteries using silicon oxide as a negative electrode active material are developed. Specifically, a negative electrode material for non-aqueous electrolyte secondary cells which suppresses gas generation by containing fluorine on the surface of the negative electrode material comprising silicon and/or a silicon alloy to form a silicon fluorine bond or the like (Patent Document 1) is reported.

In addition, to reduce irreversible capacity in a negative electrode such as silicon oxide, a method of adsorbing lithium of an amount corresponding to irreversible capacity on the surface of the negative electrode active material by immersing a negative electrode active material in a solution of lithium in aqueous ammonia or a solution of n-butyl lithium in an organic solvent such as hexane (Patent Document 2), and a method of adsorbing an alkali metal or an alkaline earth metal on a negative electrode material by bringing a metallic solution of the alkali metal or alkaline earth metal in an amine compound solvent in contact with a negative electrode material such as silicon oxide (Patent Document 3) are known.

However, negative electrode materials for non-aqueous electrolyte secondary cells disclosed in Patent Document 1 cannot sufficiently suppress gas generation. Accordingly, there is a need for lithium secondary batteries capable of efficiently suppressing gas generation which is suitable for use in batteries using silicon oxide for a negative electrode and using an aluminum laminate film for an outer package.

### PRIOR ART DOCUMENTS

### Patent Documents

Patent Document 1: JP Patent Application Publication No. 2005-11696

Patent Document 2: JP Patent Application Publication Hei. 10-294104

Patent Document 3: JP Patent Application Publication No. 2000-195505

### SUMMARY OF THE INVENTION

An object of the present invention is to provide a lithium secondary battery that can suppress gas generation upon charge/discharge although the lithium secondary battery comprises silicon and silicon oxide as negative electrode active materials and suppress deformation although an aluminum laminate film is used for an outer package and a method for manufacturing the same.

As a result of repeated and extensive research, the present inventors found that gas generation upon charge/discharge of lithium secondary batteries is caused by decomposition of electrolytic solution by active sites contained in silicon and silicon oxide of a negative electrode active material and it can be suppressed by previously performing reduction treatment on silicon and silicon oxide to inactivate active sites thereafter forming a negative electrode active material layer using the treated silicon and silicon oxide as a raw material. The present invention has been completed based on this founding.

That is, the present invention relates to a lithium secondary battery comprising a negative electrode containing a negative electrode active material, a positive electrode containing a positive electrode active material, and an electrolytic solution used to immerse the positive and negative electrode active materials, wherein the negative electrode active material comprises silicon and silicon oxide that have been subjected to a reduction treatment.

In addition, the present invention relates to a method for manufacturing a lithium secondary battery comprising being subjected to reduction treatment of negative electrode active material as immersing silicon particles and silicon oxide particles in a solution containing an alkali metal or an alkali compound and stirring them, thereafter forming a negative electrode active material layer using the silicon particles and silicon oxide particles.

The lithium secondary battery according to the present invention can suppress gas generation upon charge/discharge although it comprises silicon and silicon oxide as negative electrode active materials and can suppress deformation although a resin film is used for an outer package.

### BRIEF DESCRIPTION OF THE DRAWINGS

FIG. 1 is a view illustrating a configuration of an example of a lithium secondary battery according to the present invention.

1 Negative electrode active material layer

2 Negative electrode current collector

3 Negative electrode

4 Positive electrode active material layer

5 Positive electrode current collector

6 Positive electrode

7 Separator

8 Outer package

### DETAILED DESCRIPTION OF THE INVENTION

The lithium secondary battery according to the present invention comprises a positive electrode, a negative electrode and an electrolytic solution in which the positive and negative electrodes are immersed.

### [Negative Electrode]

The negative electrode may have a structure in which a negative electrode active material layer including a negative electrode active material performing charge/discharge by absorbing and releasing lithium ions and an optionally added conductive agent integrated by a binder is formed on a negative electrode current collector.

The negative electrode active material comprises silicon and silicon oxide. The negative electrode active material may comprise carbon and other metal in addition to silicon and silicon oxide. In addition, silicon and silicon oxide coated with carbon or silicon and silicon oxide integrally formed with carbon (these are referred to as carbon composites) may be used. The silicon oxide may be a compound represented by formula of SiOₓ:0<x<2 (excluding x=1) in addition to SiO, SiO₂ or the like. Mixed particles obtained by mixing silicon and silicon oxide may for example have a mean particle diameter of 1 to 10 μm, preferably 2 to 8 μm, more preferably, 3 to 7 μm.

Such silicon and silicon oxide may be ingredients for forming the negative electrode active material and are subjected to reduction treatment prior to use. The reduction treatment means treatment for inactivating active sites of silicon and a silicon compound formed as negative electrode active materials in lithium secondary batteries that react with the electrolytic solution or the like with charge/discharge reactions. This reduction treatment enables inactivation of silicon oxides contained as impurities in silicon or of active sites of the silicon oxides.

The reduction treatment is preferably carried out by bringing silicon and silicon oxide in contact with an alkali metal or a solution containing an alkali metal or an alkali compound (also referred to as “alkali solution”).

The contact with the alkali metal is contact with an alkali metal such as Li, K or Na and is for example contact with an alkali metal powder or silicon and silicon oxide powders, or deposition of an alkali metal on silicon and silicon oxide. The deposition may be carried out using vacuum deposition, sputtering or the like.

In addition, the alkali solution is for example a mixture of an alkali metal such as Li, K or Na and an organic solvent. The organic solvent is for example ether, tetrahydrofuran or the like or a polycyclic aromatic compound which is capable to form a complex of an alkali metal.

In addition, examples of the alkali compound contained in the alkali solution include alkyl alkali compounds such as alkyl lithium for example n-butyl lithium, propyl lithium, n-pentyl lithium or n-hexyl lithium. As the organic solvent, in addition to the solvent described, hexane or the like may be used.

Such an alkali solution preferably has a potential not less than 0.2V to not more than 1.0V nobler than a reductive deposition potential of lithium. By treating with the alkali solution having a potential satisfying this range with respect to the deposition potential of lithium, the effect of suppressing reaction of silicon or silicon oxide with the electrolytic solution can be improved during charge/discharge reactions wherein the silicon and silicon oxide absorb and release lithium ions. The alkali solution having the potential defined above can be obtained by controlling a concentration of the alkali metal or alkali compound in the alkali solution.

The contact between the alkali solution and the silicon and silicon oxide is for example implemented by immersion, application and spray application or the like. If necessary, suitable stirring may be performed. Treatment time may be determined according to active site amount of silicon oxide. After reduction treatment, washing with an organic solvent and drying are preferably performed. By washing with the organic solvent, residues of excessive alkali metal or alkali compound and residues of water can be suppressed. Treatment temperature at which the alkali solution contacts silicon and silicon oxide may be room temperature, but may be 40° C. to 90° C. or 50° C. to 80° C. Treatment time is for example 30 minutes to 2 hours and is preferably 30 minutes to 1 hour.

Examples of carbon used for carbon composites include graphite, hard carbon or the like. These materials may be used alone or in combination of two or more thereof.

Furthermore, in addition to the materials described above, the negative electrode active material may contain a metal such as Al, Si, Pb, S, Zn, Cd, Sb, In, Bi, Ag, Ba, Ca, Hg, Pd, Pt, Te, or La, an alloy of two or more thereof, or an alloy of the metal and lithium or an alloy of the alloy and lithium, or the like. In addition, the negative electrode active material may contain metal oxides such as aluminum oxide, tin oxide, indium oxide, zinc oxide, lithium oxide, lithium iron oxide, tungsten oxide, molybdenum oxide, copper oxide, tin oxide such as SnO or SnO₂, niobium oxide, LiₓTi₂₋ₓO₄(1≤x≤4/3), lead oxide such as PbO₂ or Pb₂O₅, metal sulfides such as SnS or FeS₂, polyacene or polythiophene, or lithium nitride such as Li₅(Li₃N), Li₇MnN₄, Li₃FeN₂, Li_{2.5}Co_{0.5}N or Li₃CoN.

Examples of the conductive agent used for the negative electrode include carbon black, acetylene black or the like. A content of the conductive agent in the negative electrode active material is for example 1 to 10 parts by weight with respect to 100 parts by weight of the negative electrode active material. As a binder for the negative electrode, a thermosetting resin such as polyimide, polyamide, polyamideimide, a polyacryalic acid resin or a polymethacrylic acid resin may be used. The amount of the binder used for the negative electrode is preferably 1 to 30% by weight, more preferably 2 to 25% by weight, with respect to a total amount of the negative electrode active material and the binder for the negative electrode. Adhesion between the active materials and between the active material and the current collector and cycle properties are improved by adjusting the content of the negative electrode binder to 1% or more by weight and negative electrode capacity is enhanced by adjusting the content of the negative electrode binder to 30% or less by weight.

Any negative electrode current collector may be used as long as it can support the negative electrode active material layer including the negative electrode active material integrated by the binder and have conductivity enabling conduction to an exterior terminal. A material for the negative electrode current collector is preferably aluminum, copper, silver or an alloy thereof. The negative electrode current collector for example has a foil, plate or mesh shape.

The thickness of the negative electrode current collector is determined so that it maintains a strength supporting the negative electrode active material layer and is for example 4 to 100 μm and is preferably 5 to 30 μm.

The negative electrode active material layer preferably has an electrode density not less than 0.5 g/cm³ and not more than 2.0 g/cm³. When the electrode density of the negative electrode active material layer is 0.5 g/cm³ or more, decrease in absolute value of discharge capacity can be suppressed. Meanwhile, when the electrode density of the negative electrode active material layer is 2.0 g/cm³ or less, impregnation of electrolytic solution in electrodes is easy and the effect of suppressing deterioration in discharge capacity is excellent.

The negative electrode active material layer can be formed by coating an ingredient for the negative electrode active material layer obtained by mixing a powder of the negative electrode active material comprising silicon and silicon oxide that have been subjected to reduction treatment and the binder for the negative electrode with an optionally added conductive agent and a solvent such as N-methyl-2-pyrrolidone (NMP) onto the current collector by a doctor blade, die-coater method or the like and drying the coating under a high temperature atmosphere. Or, the negative electrode active material layer may be rolled to obtain an applied electrode plate or may be directly pressed to obtain a pressed electrode plate. In addition, the negative electrode active material layer may be manufactured by drying the film under a high temperature atmosphere after coating.

### [Positive Electrode]

The positive electrode may have a structure in which a positive electrode active material layer including a positive electrode active material performing charge/discharge by absorbing and releasing lithium ions and an optionally added conductive agent integrated by a binder is formed on a positive electrode current collector.

The positive electrode active material include specifically examples of LiCoO₂, LiNiO₂ or those wherein a part of transition metals of LiCoO₂ or LiNO₂ is substituted by one or two or more of Al, Fe, P, Ti, Si, Pb, Sn, In, Bi, Ag, Ba, Ca, Hg, Pd, Pt, Te, Zn and La, lithium manganese oxides having layered crystal structures such as LiMnO₂, LiₓMn₂O₄(0<x<2), LiₓMn_{1.5}Ni_{0.5}O₄(0<x<2) , lithium manganese oxides having spinel crystal structures or the like. The positive electrode active material may be used alone or in combination of two or more thereof.

Examples of the conductive agent used for the positive electrode may be the same as those of the negative electrode specifically exemplified. The content of the conductive agent in the positive electrode active material layer is for example 3 to 5 parts by weight with respect to 100 parts by weight of the positive electrode active material. Examples of the binder for the positive electrode include polyvinylidene fluoride (PVdF), vinylidene fluoride-hexafluoropropylene copolymers, vinylidene fluoride-tetrafluoroethylene copolymers, polytetrafluoroethylene or the like. Of these, polyvinylidene fluoride is preferred in terms of generality and low cost. A content of the binder for positive electrode used is preferably 2 to 10 parts by weight with respect to 100 parts by weight of the positive electrode active material in terms of energy density and adhesion control.

Any positive electrode current collector may be used as long as it supports the positive electrode active material layer including the positive electrode active material integrated by the binder and has conductivity enabling conduction to an exterior terminal. The material of the positive electrode current collector is for example the same as that of the negative electrode current collector and the thickness thereof is also the same as that of the negative electrode current collector.

The positive electrode active material layer preferably has an electrode density not less than 2.0 g/cm³ and not more than 3.0 g/cm³. When the electrode density of the positive electrode is 2.0 g/cm³ or more, the effect of suppressing a decrease in absolute value of discharge capacity can be improved. Meanwhile, when the electrode density of the positive electrode is 3.0 g/cm³ or less, impregnation of electrolytic solution in electrodes is easy and the effect of suppressing deterioration in discharge capacity is thus improved.

The positive electrode active material layer may be produced by forming an ingredient for the positive electrode active material layer obtained by dispersing a powdery positive electrode active material, an optionally added conductive agent powder and the binder for the positive electrode in a solvent such as N-methyl-2-pyrrolidone (NMP) or dehydrated toluene and then mixing, on the current collector in the same manner as the production method of the negative electrode active material layer. In addition, the positive electrode active material layer may be formed by CVD, a sputtering method or the like. A positive electrode active material layer is previously formed and a film made of aluminum, nickel or an alloy of thereof is then formed as a positive electrode current collector by a method such as deposition or sputtering.

### [Electrolytic Solution]

The electrolytic solution is obtained by dissolving an electrolyte in a non-aqueous organic solvent and is capable of dissolving lithium ions. The positive electrode active material layer and the negative electrode active material layer are immersed in the electrolytic solution so that the positive and negative electrodes can absorb and release lithium ions during charge/discharge.

Preferably, the solvent of the electrolytic solution has flowability to sufficiently immerse the positive and negative electrodes in terms of long lifespan of the batteries. According to the reduction treatment of the negative electrode active material, decomposition of electrolytic solution and gas generation can be suppressed even upon repeated charge/discharge. Accordingly, ester carbonate can be preferably used. Examples of the solvent for electrolytic solution include cyclic ester carbonates such as propylene carbonate (PC), ethylene carbonate (EC), butylene carbonate (BC) or vinylene carbonate (VC); chain ester carbonates such as dimethylcarbonate (DMC), diethylcarbonate (DEC), ethylmethylcarbonate (EMC) or dipropylcarbonate (DPC); aliphatic carboxylic acid esters such as methyl formate, methyl acetate or ethyl propionate; y-lactones such as y-butyrolactone; chain ethers such as 1,2-ethoxyethane (DEE) or ethoxymethoxyethane (EME); cyclic ethers such as tetrahydrofuran or 2-methyltetrahydrofuran; aprotic organic solvents such as dimethylsulfoxide, 1,3-dioxolane, formamide, acetamide, dimethylformamide, dioxolane, acetonitrile, propyl nitrile, nitromethane, ethylmonoglyme, phosphate triester, trimethoxymethane, dioxolane derivatives, sulforane, methylsulforane, 1,3-dimethyl-2-imidazolidinone, 3-methyl-2-oxazolidinone, propylene carbonate derivatives, tetrahydrofuran derivatives, ethylether, 1,3-propanesultone, anisole or N-methylpyrrolidone. These solvents may be used alone or in combination of two or more thereof.

As electrolytes that are contained in the electrolytic solution, lithium salts are preferably used. Examples of lithium salts may include LiPF₆, LiAsF₆, LiAlCl₄, LiClO₄, LiBF₄, LiSbF₆, LiCF₃SO₃, LiC₄F₉CO₃, LiC(CF₃SO₂)₃, LiN(CF₃SO₂)₂, LiN(C₂F₅SO₂)₂, LiB₁₀Cl₁₀, lower aliphatic lithium carboxylate, chloroborane lithium, lithium tetraphenylborate, LiBr, LiI, LiSCN, LiCl, imides, boron fluorides, or the like. These electrolytes may be used alone or in combination of two or more thereof.

In addition, instead of the electrolytic solution, a polymer electrolyte, an inorganic solid electrolyte, an ionic liquid or the like may be also used.

A concentration of the electrolyte in the electrolytic solution is preferably not less than 0.01 mol/L and not more than 3 mol/L, and more preferably not less than 0.5 mol/L and not more than 1.5 mol/L. When the concentration of the electrolyte is within the ranges indicated above, batteries having improved stability, increased reliability, and lowered environmental loads may be obtained.

### [Separator]

Any separator may be used as long as it suppresses a contact between the positive electrode and the negative electrode, allows penetration of charge carriers, and has durability in the electrolytic solution. Specific materials suitable for the separator may include polyolefin, for example polypropylene or polyethylene based microporous membranes, celluloses, poly-ethylene terephthalate, polyimide, polyfluorovinylidene, or the like. They may be used as a form such as porous film, fabric or nonwoven fabric.

### [Outer Package]

Preferably, the outer package has strength to stably hold the positive electrode, the negative electrode, the separator and the electrolytic solution, is electrochemically stable to these components, and has water-tightness and air-tightness. As specific examples, stainless steel, nickel-plated iron, aluminum, titanium, or alloys thereof or those plating, metal laminate resins or the like may be used. As resins suitable for the metal laminate resins, polyethylene, polyethylene terephthalate, polypropylene and the like may be used. They may be used as a structure of a single layer or two or more layers.

### [Lithium Secondary Battery]

A form of the lithium secondary battery may have any of cylindrical, flat winding rectangular, stacked rectangular, coin, winding laminate, flat winding laminate, stacked laminate forms or the like.

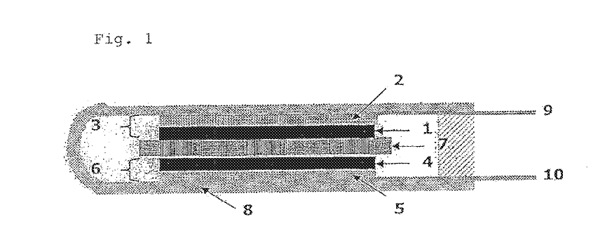

The lithium secondary battery as indicated above is for example a film-externally provided secondary battery having an outer package including a resin film shown in FIG. 1. The film-externally provided secondary battery has a structure in which a negative electrode 3 including a negative electrode active material layer 1 formed on a negative electrode current collector 2 such as a copper foil and a positive electrode 6 including a positive electrode active material layer 4 formed on a positive electrode current collector 5 such as aluminum foil face each other via a separator 7. A negative electrode lead tag 9 and a positive electrode lead tag 10 for ejecting electrode terminals from the negative electrode current collector 2 and the positive electrode current collector 5 have an end exposed to the outside of an outer package 8 and a portion of each of the negative and positive electrode lead tags 9 and 10 excluding the end is accommodated within the outer package 8. The outer package 8 is filled with an electrolytic solution (not shown).

### [Manufacturing Method]

A method for manufacturing the lithium secondary battery according to the present invention comprises being subjected to reduction treatment of negative electrode active material as immersing silicon particles and silicon oxide particles in a solution containing an alkali metal or an alkali compound and stirring them, thereafter forming a negative electrode active material layer using the silicon particles and silicon oxide particles.

### EXAMPLE

Hereinafter, the lithium ion secondary cell according to the present invention will be described in detail.

### Example 1

### [Reduction Treatment]

A powder of a carbon composite that contains silicon (Si) and silicon oxide (SiO₂) at a molar ratio of 1:1 and is coated with 3% by weight of carbon with respect to Si and SiO₂ was used.

Reduction treatment of silicon and silicon oxide was performed by bringing 10 g of the carbon composite in contact with a lithium metal powder at a nitrogen atmosphere of 80° C. for 60 minutes to obtain an ingredient for the negative electrode active material. The ingredient for the negative electrode active material was brought in contact with a carbonate-based electrolytic solution and was then stored in a film outer package at 60° C. for 10 days.

### [Manufacturing of Battery]

An active material layer of a negative electrode was manufactured by applying an electrode material for a negative electrode containing the negative electrode active material ingredient obtained by reduction treatment, polyimide as a binder, and NMP to a 10 μm copper foil, drying the applied material at 125° C. for 5 minutes, press-molding the same with a roll-press and drying the resulting product at a nitrogen atmosphere in a drying furnace at 350° C. for 30 minutes. The copper foil provided with the negative electrode active material layer was punched at a size of 30×28 mm to obtain a negative electrode and a negative electrode lead tag made of nickel for ejecting electric charges was welded by ultrasonic waves to the copper foil of the negative electrode.

An active material layer of a positive electrode was manufactured by applying an electrode material for the positive electrode containing lithium nickel oxide, poly(vinylidene fluoride) as a binder and NMP to an aluminum foil with a thickness of 20 μm and drying the applied material at 125° C. for 5 minutes. The aluminum foil provided with the positive electrode active material layer was punched at a size of 30×28 mm to obtain a positive electrode and a positive electrode lead tag made of aluminum for ejecting electric charges was welded by ultrasonic waves to the aluminum foil of the positive electrode.

The negative electrode, the separator and the positive electrode were sequentially laminated such that active material layers face each other via the separator, a laminate film was inserted, 70 μL of an electrolytic solution was filled and sealing was performed under vacuum to manufacture a laminate-type battery. As the electrolytic solution, a solution of 1 mol/L LiPF₆ dissolved in a mixed solvent of EC, DEC and EMC at a volume ratio of 3:5:2 was used.

### [Detection of Generated Gas Amount]

The manufactured battery was stored at 60° C. for 10 days, a volume of the battery immediately after manufacturing and a volume of the battery after storage were measured and the amount of generated gas was measured from a difference between the volumes. Results are shown in Table 1.

### Example 2

The carbon composite used in Example 1 was used as silicon and silicon oxide and reduction treatment of the carbon composite was performed by supplying a nitrogen gas and depositing a lithium metal as a deposition source to the carbon composite at a reduced pressure of 10⁻³ Pa. Then, the composite having the deposited lithium metal was washed with an organic solvent to remove the residual lithium metal and thereby to obtain an ingredient for the negative electrode active material. A battery was manufactured and an amount of generated gas was measured in the same manner as in Example 1, except that the obtained negative electrode active material ingredient was used. Results are shown in Table 1.

### Example 3

The carbon composite used in Example 1 was used as silicon and silicon oxide and reduction treatment of the carbon composite was performed by immersing 10 g of the carbon composite in 100 mL of a 1.6 mol/L commercially available n-butyl lithium hexane solution for 6 hours to obtain a negative electrode active material ingredient. A potential of the n-butyl lithium hexane solution with respect to the deposition potential of lithium metal was about 1.0V. A battery was manufactured and the amount of generated gas was measured in the same manner as in Example 1, except that the obtained negative electrode active material ingredient was used. Results are shown in Table 1.

### Example 4

The carbon composite used in Example 1 was used as silicon and silicon oxide and reduction treatment of the carbon composite was performed by immersing 10 g of the carbon composite in 100 mL of a complex solution obtained by mixing a lithium metal and naphthalene with a tetrahydrofuran solution such that a lithium-naphthalene complex reached 0.1 mol/L for three hours to obtain a negative electrode active material ingredient. A potential of the n-butyl lithium hexane solution with respect to the deposition potential of lithium metal was about 0.5V. A battery was manufactured and an amount of generated gas was measured in the same manner as in Example 1, except that the obtained negative electrode active material ingredient was used. Results are shown in Table 1.

### COMPARATIVE EXAMPLE

A cell was manufactured and an amount of generated gas was measured in the same manner as in Example 1, except that the carbon composite used in Example 1 was used without reduction treatment. Results are shown in Table 1.

TABLE 1

| | | Volume of cell | Volume of | Variation |
|---|---|---|---|---|
| | | immediately after | cell after | in |
| | Reduction | manufacturing | storage for | volume |
| | treatment | (cc) | 10 days (cc) | (%) |
| Example 1 | Li metal | 77 | 85 | 110 |
| | contact | | | |
| Example 2 | Li metal | 75 | 81 | 108 |
| | deposition | | | |
| Example 3 | Immersion in | 77 | 80 | 104 |
| | N-butyl Li | | | |
| | hexane | | | |
| | solution | | | |
| Example 4 | Li | 75 | 78 | 104 |
| | naphthalene | | | |
| | complex | | | |
| | solution | | | |
| Comparative | Non-present | 75 | 95 | 126 |
| Example | | | | |

This application incorporates the full disclosure of JP Patent Application No. 2012-81118 filed on Mar. 30, 2012 herein by reference.

The present invention is applicable to all of industrial fields that require power source and industrial fields related to transmission, storage and supply of electrical energy. Specifically, the present invention is applicable to power sources for mobile devices such as cellular phones and notebook computers, power sources for driving vehicles, airplanes and the like.

1-9. (canceled)

10. A method for manufacturing a lithium secondary battery comprising being subjected to reduction treatment of negative electrode active material as immersing silicon particles and silicon oxide particles in a solution containing an alkali metal or an alkali compound and stirring them to inactivate active sites of the silicon oxide, thereafter forming a negative electrode active material layer using the silicon particles and silicon oxide particles.

11. The method of claim 10, wherein the reduction treatment is an inactivation reaction of an active site of the silicon oxide.

12. The method of claim 10, wherein the reduction treatment comprises bringing a solution containing an alkali metal or an alkali compound in contact with the silicon and the silicon oxide.

13. The method of claim 12, wherein the solution containing an alkali metal or an alkali compound has a potential not less than 0.2V to not more than 1.0V nobler than a reductive deposition potential of lithium.

14. The method of claim 12, wherein the alkali compound is an alkyl alkali compound.

15. The method of claim 12, wherein the solution containing an alkali metal or an alkali compound contains an organic solvent.

16. The method of claim 15, wherein the organic solvent is tetrahydrofuran.

17. The method of claim 10, wherein the electrolytic solution contains ester carbonate.

18. The method of claim 10, wherein a resin film is used as an outer package.
